(19) United States
(12) Patent Application Publication
(10) Pub. No.: US 2026/0297316 A1
(43) Pub. Date: Oct. 1, 2026

(54) FOAMABLE COMPOSITE RESIN PARTICLES, METHOD OF PRODUCING THE SAME, FOAMED PARTICLES, METHOD OF PRODUCING THE SAME, FOAMED MOLDED ARTICLE, AND AUTOMOBILE MEMBER

(71) Applicant: SEKISUI KASEI CO., LTD., Osaka (JP)

(72) Inventor: Hiroki OWAKI, Osaka (JP)

(73) Assignee: SEKISUI KASEI CO., LTD., Osaka (JP)

(21) Appl. No.: 19/577,989

(22) Filed: Mar. 25, 2026

(30) Foreign Application Priority Data
Mar. 28, 2025 (JP) 2025-055314
Jan. 13, 2026 (JP) 2026-003834

(51) Int. Cl. C08L 25/06; C08J 9/00; C08J 9/14; C08J 9/18; C08J 9/232; C08K 5/20

(52) U.S. Cl. CPC C08L 25/06; C08J 9/0028; C08J 9/0061; C08J 9/141; C08J 9/18; C08J 9/232; C08K 5/20; C08J 2203/14; C08J 2205/044; C08J 2325/06; C08J 2423/08; C08J 2423/12; C08L 2201/02; C08L 2203/14; C08L 2205/025; C08L 2205/03

(57) ABSTRACT

[Object] An object of the present invention is to provide foamable particles in which a decrease in foaming power due to cryopreservation is reduced and which have sufficient foaming power after cryopreservation and a method of producing the same.

[Solution] The present invention relates to foamable particles that are obtained by incorporating a foaming agent into composite resin particles prepared by impregnating and polymerizing styrene monomers into seed particles containing a polypropylene resin and an ethylene-vinyl acetate copolymer, the foaming agent is pentane,
the water content of the foamable particles with respect to the mass of the foamable particles is 1 mass % or less, and
(1) the foamable particles contain 0.1 to 4.0 mass % of a carbon component with respect to the mass of the foamable particles and the mass average molecular weight (in terms of polystyrene) of the foamable particles is 250,000 to 550,000, or
(2) the foamable particles do not contain a carbon component or contain less than 0.1 mass % of a carbon component with respect to the mass of the foamable particles, and the mass average molecular weight (in terms of polystyrene) of the foamable particles is 350,000 to 550,000.

### BACKGROUND OF THE INVENTION

### 1. Field of the Invention

The present invention relates to foamable composite resin particles, a method of producing the same, foamed particles, a method of producing the same, foamed molded articles, an automobile member and the like.

### 2. Description of the Related Art

Foamed molded articles made of polystyrene resins are excellent in terms of rigidity, thermal insulation, being lightweight, water resistance and foam moldability, but are known to have low chemical resistance and impact resistance. To compensate for this, composite resin foamed molded articles obtained from composite resin particles made of a polystyrene resin and a polyolefin resin are used. Composite resin particles are generally produced by using a base resin of a polyolefin resin such as a polyethylene resin as seed particles (also called core particles), impregnating the seed particles with styrene monomers and then performing polymerization. This polymerization is also called seed polymerization, and composite resin particles are also called seed polymer particles. Generally, a foaming gas is added to the composite resin particles to obtain foamable particles, the foamable particles are subjected to primary foaming (also called pre-foaming) to obtain foamed particles (also called pre-foamed particles), the foamed particles are filled into a mold and heated to foam the foamed particles, the foamed particles are thermally fused together, and a foamed molded article having a shape corresponding to the internal dimensions of the mold is produced.

The properties of the composite resin foamed molded article can be changed by changing the type of the polyolefin resin constituting the composite resin particles. For example, when a polypropylene resin is used, the heat resistance is improved. Composite resin foamed molded articles with high heat resistance are in demand, particularly for automobile members, and a composite resin foamed molded article with excellent heat resistance obtained from composite resin particles made of a polypropylene resin and a polystyrene resin has been used (Japanese Patent Application Publication No. 2011-058008). However, when the pressure of a vapor used for foam molding is not high, foaming becomes insufficient, making it difficult to obtain a molded article having desired properties such as a shape and density. When the pressure of a vapor required for foam molding is high, a large amount of energy required for molding is necessary, and furthermore, it is necessary to use a molding machine capable of withstanding such a pressure, resulting in increased molding costs. In order to solve this problem, a method using seed particles obtained by adding an ethylene-vinyl acetate copolymer to a polypropylene resin is known (WO 2022/202680).

### SUMMARY OF THE INVENTION

The inventors noticed that, in the method in WO 2022/202680, although the cost required for molding can be reduced by reducing the energy required for molding, the foaming power of the foamable particles decreases during storage at room temperature, and accordingly, the lifespan of the foamable particles is shortened. The inventors further noticed that this is also the same for foamable particles containing a carbon component. Therefore, the inventors found that, when the foamable particles were cryopreserved at −25° C., although a decrease in foaming power was reduced compared to storage at room temperature, sufficient foaming power was not obtained. An object of the present invention is to provide foamable particles in which a decrease in foaming power due to cryopreservation is reduced and which have sufficient foaming power after cryopreservation and a method of producing the same.

Methods of impregnating composite resin particles (seed polymer particles) with a foaming agent include a dry method and a wet method. The dry method is a method of impregnating composite resin particles with a foaming agent without using an aqueous medium such as water. The wet method is a method in which a foaming agent is impregnated into composite resin particles in the presence of an aqueous medium such as water and optionally a surfactant, and dehydration and drying are then performed. The dry method is advantageous in that it does not require facilities required for dehydration and drying. The inventors noticed that, in the dry method, foamable particle bubbles become coarse, and do not foam uniformly during foam molding (poor foam moldability). An object of the present invention is to provide a method of producing foamable particles that does not generate coarse bubbles even in a dry method and exhibits excellent foam moldability.

The inventors conducted extensive studies and as a result, found that, by adjusting production conditions such as the amount of a bubble adjusting agent used, a foaming agent addition method, and the molecular weight of foamable particles, foamable particles in which a decrease in foaming power is reduced even during cryopreservation are obtained, and coarse bubbles are not generated even when foamable particles are produced in a dry method, and completed the present invention.

The present invention includes, for example, the following aspects.

### Aspect 1.

Foamable particles comprising a polypropylene resin, an ethylene-vinyl acetate copolymer, a polystyrene resin, and a foaming agent,
wherein the foamable particles are obtained by incorporating a foaming agent into composite resin particles prepared by impregnating and polymerizing styrene monomers into seed particles containing a polypropylene resin and an ethylene-vinyl acetate copolymer,
the foaming agent is pentane,
the water content of the foamable particles with respect to the mass of the foamable particles is 1 mass % or less, and
(1) the foamable particles contain 0.1 to 4.0 mass % of a carbon component with respect to the mass of the foamable particles and the mass average molecular weight (in terms of polystyrene) of the foamable particles is 250,000 to 550,000, or
(2) the foamable particles do not contain a carbon component or contain less than 0.1 mass % of a carbon component with respect to the mass of the foamable particles, and the mass average molecular weight (in terms of polystyrene) of the foamable particles is 350,000 to 550,000.

### Aspect 2.

The foamable particles according to Aspect 1, wherein the content of the polypropylene resin is 2 to 50 mass %, the content of the ethylene-vinyl acetate copolymer is 2 to 45 mass %, the content of the polystyrene resin is 40 to 95 mass, and the mass ratio (PP:EVA) of the content (PP) of the polypropylene resin to the content (EVA) of the ethylene-vinyl acetate copolymer is 50:50 to 85:15.

### Aspect 3.

The foamable particles according to Aspect 1 or 2, wherein the content of pentane with respect to the mass of the foamable particles is 6 to 15 mass %.

### Aspect 4.

The foamable particles according to any one of Aspects 1 to 3, wherein the foamable particles contain 0.1 to 4.0 mass % of a carbon component with respect to the mass of the foamable particles and contain 1.5 to 6.0 mass % of a flame retardant with respect to the mass of the foamable particles excluding the mass of the flame retardant, and the mass average molecular weight (in terms of polystyrene) of the foamable particles is 250,000 to 550,000.

### Aspect 5.

The foamable particles according to any one of Aspects 1 to 4, which contain 0.3 to 2.5 parts by mass of a bubble adjusting agent with respect to 100 parts by mass of the foamable particles.

### Aspect 6.

The foamable particles according to Aspect 5, wherein the bubble adjusting agent is ethylene bis(stearamide) and/or a polyethylene wax.

### Aspect 7.

The foamable particles according to any one of Aspects 1 to 6, which have a bulk density of 20 kg/m³ to 50 kg/m³.

### Aspect 8.

Foamed particles obtained by pre-foaming the foamable particles according to any one of Aspects 1 to 7.

### Aspect 9.

The foamed particles according to Aspect 8, which have an average bubble diameter of 80 μm to 400 μm.

### Aspect 10.

A foamed molded article made from a fused component of the foamed particles according to Aspect 8 or 9.

### Aspect 11.

The foamed molded article according to Aspect 10, which has a density of 20 kg/m³ to 50 kg/m³.

### Aspect 12.

An automobile member containing the foamed molded article according to Aspect 10 or 11.

### Aspect 13.

A method of producing foamable particles containing a polypropylene resin, an ethylene-vinyl acetate copolymer, a polystyrene resin, and a foaming agent,
wherein the foamable particles are foamable particles according to any one of Aspects 1 to 7, and
the foaming agent is pentane,
the production method includes a step in which, in a sealed container, without using an aqueous medium, pentane is added and impregnated into composite resin particles prepared by impregnating and polymerizing styrene monomers into seed particles containing a polypropylene resin and an ethylene-vinyl acetate copolymer to obtain foamable particles, and
pentane addition and impregnation are performed at a temperature from a temperature (T+10) (10° C. higher than the boiling point (T) of pentane) to a temperature (T+60) (60° C. higher than the boiling point (T) of pentane).

### Aspect 14.

The method of producing foamed particles according to Aspect 8, including freezing the foamable particles according to any one of Aspects 1 to 7; thawing the frozen foamable particles; and pre-foaming the thawed foamable particles.

According to the present invention, it is possible to provide foamable particles, and even if the foamable particles are cryopreserved and thawed, the foamed particles obtained from the thawed foamable particles have required foaming power.

According to the present invention, it is possible to provide foamed particles having excellent foam moldability due to the absence of coarse bubbles.

According to the method of producing foamable particles of the present invention, although the foaming agent is dry-impregnated into the composite resin particles, the foamed particles obtained from the foamable particles produced by this production method do not contain coarse bubbles. When the foamed particles do not contain coarse bubbles, the foamed particles uniformly foam during foam molding and a foamed molded article having a shape that conforms to the shape of the mold and having excellent compressive strength is obtained.

In the method of producing foamed particles of the present invention, even when the cryopreserved and thawed foamable particles are used, it is possible to produce foamed particles having sufficient foaming power.

### BRIEF DESCRIPTION OF THE DRAWINGS

FIG. 1 is a scanning electron microscope (SEM) image showing a cross section of a foamed particle obtained from frozen foamable particles produced in Example 1.

### DESCRIPTION OF THE PREFERRED EMBODIMENTS

In this specification, the term “comprising” is intended to encompass the term “consisting essentially of” and the term “consisting of.”

The numerical ranges described in this specification can be arbitrarily combined with the upper limit values or lower limit values of other numerical ranges of the same type. In addition, in the numerical ranges described in this specification, the upper limit value or lower limit value of the numerical range may be replaced with a value shown in examples or a value that can be uniquely derived from examples.

In this specification, numerical values indicated using “to” mean a numerical range including numerical values stated before and after “to” as the lower limit value and the upper limit value. For example, “1 to 10 mass %” has the same meaning as “1 mass % or more and 10 mass % or less.”

In this specification, regarding numerical ranges, “or more” means “the same or exceeding” and “or less” means “the same or less than”. For example, “10 or more” has the same meaning as “10 or exceeding 10.”

Foamable particles of the present invention may contain a polypropylene resin, an ethylene-vinyl acetate copolymer, a polystyrene resin, and a foaming agent. The foamable particles of the present invention can be produced by using base resins of a polypropylene resin and an ethylene-vinyl acetate copolymer as seed particles, impregnating the seed particles with styrene monomers and then performing polymerization to produce composite resin particles, and adding a foaming gas to the composite resin particles. The foamable particles can be subjected to primary foaming (also called pre-foaming) to produce foamed particles (also called pre-foamed particles). The foamed particles are filled into a mold and heated to foam foamed particles, the foamed particles are thermally fused together to form an integrated thermally fused component, and thereby a foamed molded article having a shape corresponding to the internal dimensions of the mold can be produced.

The composite resin particles are typically obtained by impregnating base resin particles (seed particles) with styrene monomers and polymerizing the styrene monomers. The base resin contains at least a polypropylene resin and an ethylene-vinyl acetate copolymer. The total content of the polypropylene resin and the ethylene-vinyl acetate copolymer in the seed particles with respect to the mass of the seed particles may be, for example, 80 to 100 mass %, 85 to 100 mass %, 90 to 100 mass %, or 95 to 100 mass %.

### Polypropylene Resin

The polypropylene resin is not particularly limited, and known resins can be used. Examples of polypropylene resins include homopolymers, random copolymers, and block copolymers. Random copolymers are preferable because they have high moldability (that is, they can be foam-molded due to high fusibility at a low vapor pressure and tend to exhibit a high foaming ratio during foaming).

As the polypropylene resin, recycled products, for example, recycled resins obtained by collecting polypropylene resins used as packaging materials or the like and recycling them, can be used.

The copolymer may contain olefins other than propylene (for example, ethylene, butene, etc.). Examples of random copolymers include ethylene-propylene random copolymers, propylene-butene random copolymers, and ethylene-propylene-butene random copolymers. Examples of block copolymers include ethylene-propylene block copolymers, propylene-butene block copolymers, and ethylene-propylene-butene block copolymers.

The proportion of components derived from olefins other than propylene in the copolymer can be, for example, 0.01 to 10 mass %, 0.01 to 8 mass %, 0.1 to 7 mass %, or 0.1 to 6 mass %, is preferably 1 to 7 mass %, and more preferably 2 to 6 mass %.

Commercially available resins can be used as the polypropylene resin. For example, they are commercially available from Prime Polymer Co., Ltd., SunAllomer Ltd., and Sumitomo Chemical Co., Ltd.

The melting point of the polypropylene resin is not particularly limited, and can be, for example, 130 to 165° C., or 135 to 145° C., is preferably 130 to 150° C., more preferably 130 to 145° C., and still more preferably 130 to 134° C. When the melting point is within the above range, it is advantageous in that the moldability (high fusion rate) at a low vapor pressure is improved or the foaming ratio tends to be high during foaming. The melting point can be determined by the method described in examples.

The content of the polypropylene resin in the seed particles with respect to the mass of the seed particles, can be, for example, 10 to 80 mass %, 10 to 70 mass %, 10 to 60 mass %, 18 to 70 mass %, 40 to 80 mass %, or 50 to 80 mass %, is preferably 30 to 80 mass %, more preferably 40 to 70 mass %, and still more preferably 50 to 70 mass %.

The content of the polypropylene resin in the composite resin particles, foamable particles, foamed particles, and foamed molded article with respect to the mass of the composite resin particles, foamable particles, foamed particles, and foamed molded articles can be, for example, 2 to 50 mass %, or 2 to 35 mass %, is preferably 4 to 30 mass %, and more preferably 10 to 30 mass %.

When the content of the polypropylene resin in the seed particles, composite resin particles, foamable particles, foamed particles, and foamed molded article is within the above range, it is advantageous in that the adhesion between the foamable particles during cryopreservation is low, the foaming power of the foamed particles obtained from the frozen foamable particles is high, the compressive strength of the foamed molded articles is high, and the foamed molded article is flame retardant.

### Ethylene-Vinyl Acetate Copolymer

The ethylene-vinyl acetate copolymer is a copolymer of ethylene and vinyl acetate. The ethylene-vinyl acetate copolymer is superior to a copolymer of ethylene and other ester monomers (for example, alkyl acrylate, alkyl methacrylate, vinyl aliphatic saturated monocarboxylate (excluding vinyl acetate)) in that the amount of powder generated when composite resin foamed particles are produced is small or the rate of change in dimensions of the foamed molded article upon heating is small.

As the ethylene-vinyl acetate copolymer, recycled products, for example, recycled resins obtained by collecting ethylene-vinyl acetate copolymers used as packaging materials or the like and recycling them can be used.

The proportion of components derived from vinyl acetate in the ethylene-vinyl acetate copolymer is preferably 1 to 20 mass %, more preferably 1 to 14 mass %, and still more preferably 1 to 10 mass %.

The melting point of the ethylene-vinyl acetate copolymer is not particularly limited, and is, for example, 85 to 120° C., preferably 100 to 120° C., more preferably 100 to 115° C., and still more preferably 100 to 110° C. When the melting point is within the above range, it is advantageous in that the rate of change in dimensions of the foamed molded article upon heating is small or the fusibility during foam molding is excellent due to favorable compatibility with the polypropylene resin. The melting point can be determined by the method described in examples.

The content of the ethylene-vinyl acetate copolymer in the seed particles with respect to the mass of the seed particles can be, for example, 20 to 90 mass %, 30 to 90 mass %, 40 to 90 mass %, 30 to 82 mass %, 20 to 60 mass %, or 20 to 50 mass %, is preferably 20 to 70 mass %, more preferably 30 to 60 mass %, and still more preferably 30 to 50 mass %.

The content of the ethylene-vinyl acetate copolymer in the composite resin particles, foamable particles, foamed particles, and foamed molded articles with respect to the mass of the composite resin particles, foamable particles, foamed particles, and foamed molded articles can be, for example, 3 to 50 mass %, 2 to 45 mass %, 4 to 40 mass %, or 4 to 30 mass, is preferably 5 to 40 mass %, and more preferably 5 to 30 mass %.

When the content of the ethylene-vinyl acetate copolymer in the seed particles, composite resin particles, foamable particles, foamed particles, and foamed molded articles is within the above range, it is advantageous that the adhesion between the foamable particles during cryopreservation is low, the foaming power of the foamed particles obtained from the frozen foamable particles is high, the compressive strength is high, and flame retardancy is achieved.

In the seed particles, composite resin particles, foamable particles, foamed particles, and foamed molded article, the mass ratio (PP:EVA) of the content (PP) of the polypropylene resin to the content (EVA) of the ethylene-vinyl acetate copolymer can be, for example, 50:50 to 85:15, 50:50 to 80:20, 60:40 to 80:20, is preferably 55:45 to 80:20, more preferably 55:45 to 70:30, and still more preferably 60:40 to 70:30. When PP:EVA is within the above range, it is advantageous that the adhesion between the foamable particles during cryopreservation is low, the foaming power of the foamed particles obtained from the frozen foamable particles is high, the compressive strength is high, and flame retardancy is achieved.

### Carbon Component

The seed particles, composite resin particles, foamable particles, foamed particles, and foamed molded article may contain a carbon component. Thereby, the foamed molded article can be made black and heat resistance is improved. Examples of carbon components include carbon black (CB) such as furnace black, ketjen black, channel black, thermal black, and acetylene black, graphite, and carbon fibers.

The carbon component contained in the seed particles, composite resin particles, foamable particles, foamed particles, and foamed molded article is preferably in the form of particles, and the average particle size thereof may be 5 nm to 100 nm and is preferably 15 nm to 35 nm. Here, the average particle size of the carbon component is an average value of the diameters of the particles observed under an electron microscope. However, when the carbon component is carbon black, the average particle size of carbon black is an average value of the diameters of the particles calculated by measuring small spherical components (which have outlines formed by microcrystals and are inseparable) constituting carbon black aggregates in an electron microscope image.

The content of the carbon component in the seed particles with respect to the mass of the seed particles can be, for example, 1 to 8 mass %, or 2 to 7 mass %, is preferably 3 to 5 mass %, and more preferably 4 to 5 mass.

The content of the carbon component in the composite resin particles, foamable particles, foamed particle, and foamed molded articles with respect to the mass of the composite resin particles, foamable particles, foamed particles, and foamed molded articles can be, for example, 0.1 to 4.0 mass %, or 1.0 to 3.0 mass %, is preferably 1.0 to 2.0 mass %, and more preferably 1.0 to 1.5 mass.

When the content of the carbon component is within the above range, it is advantageous in that a sufficient black color is exhibited, the adhesion between the foamable particles during cryopreservation is low, the foaming power of the foamed particles obtained from the frozen foamable particles is high, the compressive strength is high, and flame retardancy is achieved. The carbon component may be added to and mixed with, for example, the base resin, or may be added to and mixed with the base resin as a carbon masterbatch (carbon MB).

Carbon MB can be used as a carbon component supply source. When carbon MB is used, the content of carbon MB in the seed particles, composite resin particles, foamable particles, foamed particles, and foamed molded article may be an amount corresponding to the amount of the carbon component (for example, an amount within the above range) contained in the seed particles, composite resin particles, foamable particles, foamed particles, and foamed molded article. For example, when a carbon MB containing 10 mass % of a carbon component is used, and the amount of the carbon component contained in the seed particles is set to 5 g, 50 g of carbon MB is added to the base resin and thus the amount of the carbon component contained in the seed particles can be set to 5 g.

The content of carbon MB in the seed particles with respect to the mass of the seed particles can be, for example, 5 to 30 mass %, or 10 to 25 mass %, is preferably 10 to 22 mass %, and more preferably 10 to 20 mass %.

The content of carbon MB in the composite resin particles, foamable particles, foamed particles, and foamed molded article with respect to the mass of the composite resin particles, foamable particles, foamed particles, and foamed molded articles can be, for example, 1.5 to 10.0 mass %, or 2.0 to 8.0 mass %, is preferably 2.0 to 5.0 mass %, and more preferably 2.5 to 4.0 mass %.

Carbon MB may be one in which a carbon component is dispersed in a thermoplastic resin. The resin may constitute the base resin. The resin may be a polyethylene resin or a polypropylene resin. The resins may be used alone or two or more thereof may be used in combination. When the resin contained in the carbon MB is neither a polyethylene resin nor a polypropylene resin, the resin may be other resins described below.

The polyethylene resin contained in the carbon MB may be, for example, linear low-density polyethylene (LLDPE) or high-density polyethylene (HDPE). The polyethylene resins may be used alone or two or more thereof may be used in combination.

For the polypropylene resin contained in the carbon MB, the above description of the polypropylene resin can be applied. The polypropylene resins may be used alone or two or more thereof may be used in combination.

The content of the carbon component in the carbon MB with respect to the mass of the carbon masterbatch can be, for example, 10 to 70 mass %, and is preferably 30 to 50 mass %.

The content of the thermoplastic resin in the carbon MB with respect to the mass of the carbon masterbatch can be, for example, 30 to 90 mass %, and is preferably 50 to 70 mass %.

Commercially available carbon MB can be used. For example, they are commercially available from Dainichiseika Color & Chemicals Mfg. Co., Ltd., ENEOS NUC, and DIC.

### Other Resins

The seed particles, composite resin particles, foamable particles, foamed particles, and foamed molded article may or may not contain other resins in addition to the polypropylene resin and the polyethylene resin. Examples of other resins include ethyl acrylate ester copolymers, polyester resins, and polyethylene resins other than ethylene-vinyl acetate copolymers.

The content of other resins in the seed particles, composite resin particles, foamable particles, foamed particles, and foamed molded article with respect to the total mass of the polypropylene resin and the ethylene-vinyl acetate copolymer is, for example, 0.1 to 30 mass %, preferably 0.2 to 20 mass %, and more preferably 0.3 to 10 mass %.

### Other Components

The seed particles may contain other components in addition to the polypropylene resin and the ethylene-vinyl acetate copolymer. Examples of other components include colorants, nucleating agents, stabilizing agents, filling materials (reinforcing materials), higher fatty acid metal salts, antistatic agents, lubricants, natural or synthetic oils, waxes, UV absorbing agents, weathering stabilizing agents, anti-fog agents, anti-blocking agents, slip agents, coating agents, neutron shielding agents, talc, and silica. When the seed particles contain other components, the content thereof with respect to the mass of the seed particles may be 0.001 to 10 mass %, is preferably 0.001 to 5 mass % or less, and more preferably 0.001 to 3 mass %.

### Method of Producing Seed Particles

Seed particles can be obtained by a known method used for producing seed particles for forming a foamed molded article. For example, a method in which a base resin (a polyethylene resin, an ethylene-vinyl acetate copolymer, etc.) is melt-kneaded and extruded in an extruder to obtain strands, and the obtained strands are cut in air, cut in water, or cut while heating to form granules may be used. The resin components may be mixed in a mixer before they are put into an extruder.

The seed particles may have any known shape, but a cylindrical, ellipsoidal (oval) or spherical shape is preferable. In addition, the shape is more preferably an ellipsoidal or spherical shape because the foamed particles obtained from the seed particles are favorably filled into the mold.

The seed particles preferably have an average particle size of 0.5 to 1.4 mm.

### Composite Resin Particles

The composite resin particles may contain, as resin components, at least a polypropylene resin derived from a base resin, an ethylene copolymer, and a polystyrene resin derived from a styrene monomer. The total content of the polypropylene resin, ethylene-vinyl acetate copolymer, and polystyrene resin in the composite resin particles with respect to the mass of the composite resin particles may be, for example, 80 to 100 mass %, 85 to 100 mass %, 90 to 100 mass %, or 95 to 100 mass. The composite resin particles can be produced by, for example, a seed polymerization method (impregnating seed particles with styrene monomers and polymerizing them).

The details of the type, content and the like of the components contained in the composite resin particles can also be applied to the foamable particles, foamed particles, and foamed molded article.

In seed polymerization, the amount of styrene monomers used is preferably an amount at which the total mass of the polypropylene resin and the ethylene-vinyl acetate copolymer contained in the seed particles/the amount of styrene monomers used is 5/95 to 60/40. Here, the content of the polystyrene resin in the composite resin particles is an amount corresponding to the amount of styrene monomers used. Therefore, the total mass content of the polypropylene resin and ethylene-vinyl acetate copolymer in the composite resin particles/the mass content of the polystyrene resin in the composite resin particles is preferably 5/95 to 60/40. When the amount of styrene monomers used or the mass content of the polystyrene resin is within the above range, it is advantageous in that the adhesion between the foamable particles during cryopreservation is low, the foaming power of the foamed particles obtained from the frozen foamable particles is high, the compressive strength of the foamed molded articles is high, and the foamed molded article is flame retardant. The range is more preferably 5/95 to 55/45, still more preferably 10/90 to 50/50, yet more preferably 20/80 to 45/55, and particularly preferably 20/80 to 40/60.

### Polystyrene Resin

Examples of polystyrene resins include polymers derived from styrene monomers such as styrene, α-methylstyrene, p-methylstyrene, and t-butylstyrene. In addition, the styrene polymer may be a polymer formed from styrene monomers and other monomers that can be copolymerized with styrene monomers. Examples of other monomers include polyfunctional monomers such as divinylbenzene and (meth)acrylic acid esters that do not contain a benzene ring in the structure such as (meth)butyl acrylate. Examples of (meth)acrylic acid esters include (meth)methyl acrylate, (meth)ethyl acrylate, (meth)propyl acrylate, (meth)butyl acrylate, (meth)pentyl acrylate, (meth)hexyl acrylate, and (meth)2-ethylhexyl acrylate. Methyl acrylate, ethyl acrylate, propyl acrylate, butyl acrylate, pentyl acrylate, hexyl acrylate, and 2-ethylhexyl acrylate are preferable. Butyl acrylate is more preferable. The resin components derived from these other monomers may be contained in the styrene polymer in a range not exceeding 5 mass %.

The content of the polystyrene resin in the composite resin particles, foamable particles, foamed particles, and foamed molded article with respect to the mass of the composite resin particles, foamable particles, foamed particles, and foamed molded articles can be, for example, 30 to 95 mass %, or 40 to 95 mass %, is preferably 30 to 90 mass, and more preferably 40 to 80 mass %.

The molecular weight of the resin in the composite resin particles may be a mass average molecular weight (in terms of polystyrene) of 250,000 to 550,000, 290,000 to 550,000, or 350,000 to 550,000. When the foamable particles contain 0.1 to 4.0 mass % of the carbon component with respect to the mass of the foamable particles, the molecular weight is preferably 250,000 to 550,000, more preferably 250,000 to 500,000, and still more preferably 300,000 to 450,000. When the foamable particles do not contain a carbon component or contain a carbon component in an amount of less than 0.1 mass % with respect to the mass of the foamable particles, the molecular weight is preferably 350,000 to 550,000, more preferably 350,000 to 500,000, and still more preferably 350,000 to 480,000. The same applies to the molecular weight of the resin in the foamable particles, foamed particles, and foamed molded article. When the molecular weight of the resin in the composite resin particles, foamable particles, foamed particles, and foamed molded article is within the above range, it is advantageous in that the adhesion between the foamable particles during cryopreservation is low, the foaming power of the foamed particles obtained from the frozen foamable particles is high, the compressive strength is high, and flame retardancy is achieved, and is particularly advantageous in that the foaming power of the foamed particles obtained from the frozen foamable particles is high.

### Bubble Adjusting Agent

The composite resin particles may contain a bubble adjusting agent. The bubble adjusting agent may be ethylene bis(stearamide), a polyethylene wax, a higher fatty acid bisamide, or a polyhydric alcohol. As the bubble adjusting agent, ethylene bis(stearamide) and a polyethylene wax are preferable because the bubble diameter is easily made uniform and coarse bubbles are less likely to be generated, and ethylene bis(stearamide) is more preferable. The content of the bubble adjusting agent in the composite resin particles with respect to 100 parts by mass of the resin components contained in the composite resin particles may be 0.3 to 2.5 parts by mass, is preferably 0.3 to 2.0 parts by mass, and more preferably 0.4 to 2.0 parts by mass. This content is the same for the foamable particles, foamed particles, and foamed molded articles. When the content of the bubble adjusting agent is within the above range, it is advantageous in that the foamed particles obtained from the foamable particles after cryopreservation have high foaming power.

### Flame Retardant

The composite resin particles may contain a flame retardant. In addition, since the composite resin particles have a relatively strong slow-combustion property even without containing a flame retardant, they may contain no flame retardant (for example: a halogen-based flame retardant).

Examples of flame retardants include known halogen-based flame retardants, phosphorus-based flame retardants, and inorganic flame retardants. The flame retardants may be used alone or two or more thereof may be used in combination. When the composite resin particles contain a flame retardant, the flame retardant is preferably a halogen-based flame retardant such as a bromine-based flame retardant, a chlorine-based flame retardant, or a chlorine- and bromine-containing flame retardant because it can impart high flame retardancy to the foamed molded article in a small amount.

Examples of halogen-based flame retardants include tetrabromobisphenol A, its derivatives (for example, tetrabromobisphenol A-bis(2,3-dibromo-2-methylpropyl ether), tetrabromobisphenol A-bis(2,3-dibromopropyl ether), tetrabromobisphenol A-bis(allyl ether)), triallyl isocyanurate hexabromide, tris(2,3-dibromopropyl)isocyanurate, tetrabromocyclooctane, and hexabromocyclododecane.

The content of the flame retardant with respect to the mass of the composite resin particles excluding the flame retardant can be, for example, 1.5 to 6.0 mass %, is preferably 1.5 to 4.0 mass %, and more preferably 2.0 to 3.5 mass %. This content is the same as for the foamable particles, foamed particles, and foamed molded article. When the content of the flame retardant is within the above range, it is advantageous in that it is possible to achieve both flame retardancy and heat resistance of the foamed molded article at a high level.

When the composite resin particles contain a flame retardant, they preferably contain a flame retardant assistant. When the flame retardant assistant is contained, flame retardancy imparted by the flame retardant can be further improved. Examples of flame retardant assistants include organic peroxides such as dicumyl peroxide (DCP), cumene hydroperoxide, and diacyl peroxide, 2,3-dimethyl-2,3-diphenylbutane (also known as biscumyl), and 3,4-dimethyl-3,4-diphenylhexane.

The content of the flame retardant assistant with respect to 100 parts by mass of the flame retardant is, for example, 50 parts by mass or less, preferably 10 to 40 parts by mass, and more preferably 15 to 25 parts by mass. When the content of the flame retardant assistant is within the above range, a decrease in impact resistance and heat resistance of the foamed molded article is reduced.

The composite resin particles may have any known shape, but a cylindrical, a substantially spherical or spherical shape is preferable. The shape is more preferably a substantially spherical or spherical shape because the composite resin foamed particles formed from the composite resin particles are favorably filled into the mold.

The average particle size of the composite resin particles is preferably 0.6 mm to 1.8 mm because the composite resin foamed particles are favorably filled into the mold.

### Method of Producing Composite Resin Particles

The method of producing composite resin particles is not particularly limited as long as composite resin particles described above can be obtained. As an example, composite resin particles can be obtained by the following production method. That is, composite resin particles can be obtained by polymerizing styrene monomers impregnated into the seed particles. This method is a so-called seed polymerization method.

An example of a method of producing composite resin particles using a seed polymerization method is described below.

First, seed particles, styrene monomers, and as necessary, a polymerization initiator are dispersed in an aqueous suspension. Here, when the polymerization initiator is used, the styrene monomers and the polymerization initiator may be mixed in advance before use.

As the polymerization initiator, those generally used as initiators for suspension polymerization of styrene monomers can be preferably used. Examples thereof include organic peroxides such as benzoyl peroxide, 2,2-methylenebis(4-methyl-6-t-butylphenol), di-t-butyl peroxide, t-butyl peroxybenzoate, dicumyl peroxide, 2,5-dimethyl-2,5-di-t-butylperoxyhexane, t-butylperoxy-3,5,5-trimethylhexanoate, and t-butylperoxy-2-ethylhexyl carbonate, and azo compounds such as azobisisobutyronitrile and azobisdimethylvaleronitrile. These polymerization initiators may be used alone or two or more thereof may be used. Here, dicumyl peroxide can also function as a flame retardant assistant.

Examples of aqueous media constituting an aqueous suspension include water and a medium mixture of water and a water-soluble solvent (for example, a lower alcohol).

The amount of the polymerization initiator used with respect to 100 parts by mass of the styrene monomers is preferably 0.01 to 0.9 parts by mass and more preferably 0.1 to 0.5 parts by mass.

As necessary, additives such as a bubble adjusting agent and a dispersing agent may be added to the aqueous suspension. The substances described above can be used as the bubble adjusting agent. The dispersing agent is not particularly limited, and any known dispersing agent can be used. Specific examples thereof include poorly soluble inorganic substances such as calcium phosphate, magnesium pyrophosphate, sodium pyrophosphate, and magnesium oxide. In addition, a surfactant such as sodium dodecylbenzenesulfonate may be used.

Next, the obtained dispersion solution is heated to a temperature at which the styrene monomers are not substantially polymerized and the styrene monomers are impregnated into the seed particles. The time for impregnating the seed particles with styrene monomers is not particularly limited, and can be, for example, 1 minute to 24 hours, is preferably 20 minutes to 4 hours, and more preferably 30 minutes to 2 hours.

Next, the styrene monomers are polymerized. Polymerization is not particularly limited, and is preferably performed at a temperature of 110 to 150° C., 115 to 150° C., 110 to 140° C., or 110 to 130° C., and preferably at a temperature of 120 to 140° C. for 1.5 hours to 5 hours. Polymerization is generally performed in a pressurizable sealed container. Here, it is preferable to perform impregnation and polymerization of the styrene monomers a plurality of times (for example, 2 times, 3 times, 4 times, etc.) in a divided manner. When impregnation and polymerization are performed a plurality of times in a divided manner, the generation of styrene resin polymer powder can be minimized. The powder is preferably used in a smaller amount because it shortens the lifespan of the molding die. In addition, in consideration of the decomposition temperature of the polymerization initiator, instead of starting the polymerization after the styrene monomers are impregnated into the seed particles, the polymerization may be performed while impregnating the styrene monomers.

When the polymerization is performed a plurality of times in a divided manner, in the second and subsequent polymerization steps, it is preferable to perform polymerization while adding the styrene monomers at a rate of 0.001 to 0.1 parts by mass/sec with respect to 100 parts by mass of the seed particles. In addition, when the polymerization is performed a plurality of times in a divided manner, it is preferable that, before the second polymerization, a bubble adjusting agent dispersion medium prepared by dispersing a bubble adjusting agent in an aqueous medium such as water be added dropwise and maintained at 90 to 120° C. for 0.5 to 3 hours, and the seed particles that have completed the first polymerization be impregnated.

Composite resin particles containing a flame retardant and a flame retardant assistant can be produced by a method of impregnating the flame retardant and the flame retardant assistant into seed particles together with styrene monomers or by a method of impregnating the flame retardant and the flame retardant assistant into the polymerized particles.

### Foamable Particles

Regarding foamable particles, foamed particles obtained from the foamable particles after cryopreservation have high foaming power. Therefore, the foamable particles are particularly preferable as foamable particles for cryopreservation. In other words, the foamable particles have a long lifespan during cryopreservation. The present invention also includes foamable particles after cryopreservation. Cryopreservation conditions may be, for example, conditions of −25° C. and 168 hours, but are not particularly limited as long as the foamable particles are frozen.

Unless otherwise specified, the description of foamable particles in this specification can be applied to both foamable particles that are not cryopreserved and foamable particles that are cryopreserved.

The foamable particles contain the above composite resin particles and pentane as a foaming agent.

As the foaming agent, for example, pentanes such as n-pentane, isopentane, and cyclopentane can be used. When pentane is used, the foamed particles obtained from the foamable particles after cryopreservation may have high foaming power. As pentane, isopentane is preferable. The foaming agents may be used alone or two or more thereof may be used in combination. Pentane may contain a small amount of other organic gases known as foaming agents such as propane, n-butane, and isobutane.

The content of the foaming agent in the foamable particles with respect to the mass of the foamable particles is preferably 6 to 15 mass % and more preferably 8 to 15 mass %.

The water content in the foamable particles with respect to the mass of the foamable particles may be 1 mass % or less and is preferably 0.5 mass % or less. The water content in the foamable particles with respect to the mass of the foamable particles may be 0 to 1 mass %, 0 to 0.5 mass %, 0.01 to 1 mass %, 0.01 to 0.5 mass %, 0.1 to 1 mass %, or 0.1 to 0.5 mass. When the water content is within the above range, since the adhesion between particles is inhibited when the foamable particles are cryopreserved, it is possible to reduce an operation of removing the adhered particles or individually separating the adhered particles. In order to reduce the water content, drying impregnation without using water is preferable when the composite resin particles are impregnated with pentane.

### Method of Producing Foamable Particles

The method of producing foamable particles of the present invention is not particularly limited as long as the foamable particles described above can be obtained. As an example, foamable particles can be obtained by the following production method.

That is, composite resin particles are prepared by impregnating and polymerizing seed particles containing a polypropylene resin and an ethylene-vinyl acetate copolymer with styrene monomers, and in a sealed container, without using an aqueous medium, pentane can be added to and impregnated with the composite resin particles to obtain foamable particles. When pentane is impregnated without using an aqueous medium, that is, dry impregnation with pentane is performed, the diameter of the bubbles of the foamable particles increases, which causes non-uniform foaming during foam molding and reduces moldability. However, in the present invention, when the amount of the bubble adjusting agent used and the molecular weight of the foamable particles are controlled, it is possible to prevent foamable particle bubbles from becoming large even in a dry method.

The temperature during pentane addition and impregnation is preferably a temperature from a temperature (T+10) (10° C. higher than the boiling point (T) of pentane) to a temperature (T+60) (60° C. higher than the boiling point (T) of pentane), and more preferably a temperature from a temperature (T+10) (10° C. higher than the boiling point (T) of pentane) to a temperature (T+40) (40° C. higher than the boiling point (T) of pentane). When the temperature during pentane addition and impregnation is within this range, the foamed particles obtained from the foamable particles after cryopreservation may have high foaming power.

### Foamed Particles

Foamed particles (generally referred to as pre-foamed particles) are particles obtained by preliminarily foaming composite resin particles. For example, foamed particles can be obtained by foaming frozen or non-frozen foamable particles (composite resin particles containing a foaming agent). In the present invention, the foamed particles may be foamed particles obtained from frozen foamable particles or foamed particles obtained from non-frozen foamable particles. Unless otherwise specified, the description of foamed particles in this specification can be applied to both foamed particles obtained from foamable particles that are not cryopreserved and foamed particles obtained from foamable particles that are cryopreserved.

Since foamed particles produced from foamable particles do not contain coarse bubbles, uniform foaming is performed during foam molding, and as a result, it is easy to obtain a foamed molded article having a shape that conforms to the shape of the mold (that is, a desired shape), in other words, the moldability is excellent. Regarding the foamed particles produced from foamable particles, since the foamed particles are fused together in a medium with a low vapor pressure (for example: a water vapor), the energy required for foam molding can be reduced, and therefore, the facility required for foam molding can be simplified and the cost required for foam molding can be reduced.

The bulk density of the foamed particles is preferably 10 kg/m³ to 200 kg/m³, more preferably 20 kg/m³ to 100 kg/m³, and still more preferably 20 kg/m³ to 50 kg/m³. When the bulk density is within this range, it is advantageous in that the strength of the foamed molded article is high and the foamed molded article is lightweight.

The shape of the foamed particles is preferably a spherical shape or a substantially spherical shape. The average particle size is preferably 1.0 mm to 9.0 mm and more preferably 2.0 mm to 6.4 mm.

Foamed particles can be obtained by foaming (sometimes referred to as primary foaming or pre-foaming) foamable particles to a desired bulk density by a known method. Foaming can be achieved by allowing foamable particle to be foamed using heated vapors at a gauge pressure of preferably 0.02 MPa to 0.20 MPa, and more preferably 0.02 MPa to 0.15 MPa.

The foamed particles have an average bubble diameter of preferably 50 to 500 μm, 80 to 350 μm, or 80 to 250 μm, more preferably 80 to 400 μm, and still more preferably 80 to 200 μm. When the average bubble diameter is within the above range, it is advantageous in that the adhesion between the foamable particles during cryopreservation is low, the foaming power of the foamed particles obtained from the frozen foamable particles is high, the compressive strength of the foamed molded articles is high, and the foamed molded article is flame retardant, and particularly advantageous in that the foaming power of the foamed particles obtained from the frozen foamable particles is high and the compressive strength of the foamed molded articles is high.

### Foamed Molded Articles

The foamed molded article is a foamed article made from a fused component of the foamed particles. The foamed molded article can be obtained as a thermally fused component of integrated foamed particles by a known method, for example, by filling foamed particles into a mold of a foam molding machine, heating foamed particles to foam, and thermally fusing the foamed particles together. A water vapor can be preferably used as a heating medium. Other production conditions such as a step temperature, a step pressure and a step time in each production step are appropriately set depending on the production facility, raw materials and the like to be used. In the present invention, the foamed molded article may be a foamed molded article obtained using frozen foamable particles or may be a foamed molded article obtained using non-frozen foamable particles. Unless otherwise specified, the description of the foamed molded article in this specification can be applied to both a foamed molded article obtained using non-cryopreserved foamable particles and a foamed molded article obtained using cryopreserved foamable particles.

The density of the foamed molded article is preferably 15 kg/m³ to 200 kg/m³, more preferably 20 kg/m³ to 100 kg/m³, and still more preferably 20 kg/m³ to 50 kg/m³. When the density is within the above range, both lightweight properties and strength are excellent. The density of the foamed molded article can be determined by the method described in examples.

The 25% compressive strength of the foamed molded article can be, for example, 1.0 MPa or more, 1.0 MPa to 2.0 MPa, or 1.2 MPa to 1.8 MPa, is preferably 1.3 MPa to 2.3 MPa, and more preferably 1.5 MPa to 2.5 MPa. The 25% compressive strength is determined by the method described in examples.

Regarding the flame retardancy of the foamed molded article, the burning rate determined by the method described particularly in examples, the Federal Motor Vehicle Safety Standard FMVSS 302, is preferably 80 mm/min or less, more preferably 40 mm/min or less, and still more preferably 0 mm/min (self-extinguishing). The flame retardancy is determined by the method described in examples.

The foamed molded article can be used for, for example, automobile members, cushioning materials, packaging materials, construction materials, shoe members, and sports goods. Specifically, the foamed molded article can be used for tire core materials for bicycles and wheelchairs; interior materials, seat core materials, shock absorbing members (for example; bumper core materials), and vibration absorbing members of transportation vehicles such as automobiles, railway vehicles, and airplanes; midsole members, insole members or outsole members for shoes; core materials of hitting tools for sports goods such as rackets and bats; protective tools for sports goods such as pads and protectors; medical, nursing, welfare or healthcare products such as pads and protectors; fenders; floats; toys; floor base materials; wall materials; beds; cushions; electronic components, various industrial materials, and transport containers for food and the like.

The foamed molded article is preferably used for automobile interior materials, shock absorbing members, vibration absorbing members, or part packaging materials.

### EXAMPLES

Hereinafter, one embodiment of the present invention will be described in more detail with reference to examples and the like, but the present invention is not limited thereto.

The methods for determining various physical properties and the like in examples and the like are as follows.

### Melting Point of Polypropylene Resin and Ethylene-Vinyl Acetate Copolymer

The melting point was measured by the method described in JIS K 7122:1987 “Testing methods for heat of transitions of plastics.” That is, using a differential scanning calorimeter RDC220 model (commercially available from Seiko Instruments Inc.), 7 mg of a sample was filled into a measurement container and under a nitrogen gas flow rate of 30 mL/min, the temperature was raised, lowered and raised between room temperature and 220° C. at a heating and cooling rate of 10° C./min, and the melting peak temperature of a DSC curve during second heating was taken as the melting point. In addition, when there were two or more melting peaks, the peak temperature on the lower side was taken as the melting point.

### Mass Average Molecular Weight of Composite Resin Particles

The mass average molecular weight was measured using a gel permeation chromatography (GPC) device (model: HLC-8121 GPC/HT, commercially available from Tosoh Corporation) and columns (model: TSKgel GMHhr-H(20) HT, commercially available from Tosoh Corporation).

As measurement conditions, the column temperature was set to 140° C., and 1,2,4-trichlorobenzene was used as an eluent.

The measurement sample was adjusted to a concentration of 1.0 mg/mL, and the amount thereof injected into the GPC device was 0.3 mL.

The calibration curve for each molecular weight was calibrated using a polystyrene sample with a known molecular weight, and the mass average molecular weight (Mw) was determined as a value in terms of polystyrene. Here, the mass average molecular weights of the foamable particles, the foamed particles, and the foamed molded article were the same as the mass average molecular weight of the composite resin particles that were the raw material.

### Foaming Agent Content in Foamable Particles

20 mg of a sample (foamable particles before freezing) was set in a pyrolysis furnace inlet of a pyrolysis furnace PYR-1A (commercially available from Shimadzu Corporation), purging with helium was performed for about 15 seconds, and a mixed gas when the sample was set was discharged. After sealing, the sample was inserted into a furnace core at 200° C. and heated for 120 seconds, and a gas was released. The released gas was measured under the following conditions, and a chart of the foaming agent component was obtained. Based on a calibration curve of the foaming agent component measured in advance, the foaming agent content (mass %) in the foamable particles was calculated from the obtained chart.
Measurement device: gas chromatograph GC-14B, pyrolysis furnace PYR-1A (commercially available from Shimadzu Corporation)
Column: Shimalite 60/80 NAW (Squalane 25%) 3 m×3φ detector: FID
Measurement conditions: column temperature (70° C.), inlet temperature (110° C.), detector temperature (110° C.) carrier gas (N₂), N₂ flow rate (50 mL/min), absolute calibration curve method

### Water Content of Foamable Particles

0.5 g of foamable particles before freezing was accurately weighed using a scale capable of weighing to 0.1 mg. From the accurately weighed particles, using a trace water measurement device (AQ-2100, commercially available from Hiranuma Sangyo Co., Ltd.) and an automatic heating water vaporizer (EV-2010, commercially available from Hiranuma Sangyo Co., Ltd.), under the following conditions, the total content of water generated in a heating furnace at 150° C. was measured by a Karl Fischer titration method. Here, the total amount of water in the air in the container and water adhered to the side of the container was taken as the blank water content. The water content of the foamable particles was an amount obtained by subtracting the blank water content from the total water content. In addition, the foamable particles before freezing and the foamable particles after freezing had the same water content.
Measurement environment: a room temperature of 23±2° C., a humidity of 40±10%
Vaporization temperature: 150° C.
Carrier gas (flow rate): nitrogen (100 mL/min)
Number of tests: 3
Sample amount: about 0.5 g

### Foaming Power (Bulk Factor)

For foaming power evaluation, foamable particles before freezing and foamable particles that were cryopreserved (that is, stored at −25° C. for 7 days) and then thawed at 20° C. for 3 hours were used. The mass (a (unit g)) of 2 g of the foamable particles was accurately weighed to the two decimal place, and these were heated with a water vapor at 0.07 MPa for 3 minutes to obtain foamed particles. The obtained foamed particles were placed in a 500 cm³ graduated cylinder with a minimum memory unit of 5 cm³, a pressing tool made of a circular resin plate slightly smaller than the diameter of the graduated cylinder was applied thereto, and the volume (b (unit cm³)) of the foamed particles was read. The bulk factor of the foamed particles was calculated by Formula (b)/(a). When the bulk factor was 40 or more, the foamed particles could be evaluated as having sufficient foaming power for practical use. When the bulk factor was less than 40, the foamed particles could be evaluated as not having sufficient foaming power for practical use.

### Adhesion of Foamable Particles During Cryopreservation

1,000 g of foamable particles cryopreserved at −25° C. for 7 days were placed on a sieve mesh of a JIS standard sieve (a sieve opening of 2.80 mm) in a room temperature environment. Next, the sieve was moved about 15 cm in the horizontal direction and then returned to its original position, this operation was counted as one reciprocation, and the particles were classified by reciprocating the sieve 10 times in about 10 seconds. When no particles remained on the sieve mesh, it was evaluated that the particles were not bound to each other due to freezing, and marked as ⊚ in Tables 1 and 2. When the amount of particles remaining on the sieve mesh was less than 50 g, it was evaluated that no inconvenience would occur during practical use, and marked as ∘ in Tables 1 and 2. When the amount of particles remaining on the sieve mesh was 50 g or more, it was determined that there was significant binding between the particles due to freezing, and significant inconvenience would occur in terms of operation during practical use (determination: X).

### Bulk Density of Foamed Particles

Foamed particles were filled into a graduated cylinder up to the 500 cm³ mark. However, the graduated cylinder was visually observed in the horizontal direction, and the filling was terminated when even a single composite resin foamed particle reached the 500 cm³ mark. Next, the mass of the composite resin foamed particles filled into the graduated cylinder was weighed to two decimal places in significant figures, and this mass was defined as W(g). The bulk density of the composite resin foamed particles is calculated by the following formula.

bulk density(kg/m³)=(W/500)×1000

### Density of Foamed Molded Articles

The mass (a) and the volume (b) of a test piece (75 mm×300 mm×35 mm) cut out from a foamed molded article (which was dried at 50° C. for 4 hours or longer after molding) were measured to three or more significant figures, and the density (g/cm³) of the foamed molded article was determined by Formula (a)/(b).

### 25% Compressive Strength of Foamed Molded Articles

The compressive strength was measured by the method described in JIS K 7220:2006 “Rigid cellular plastics-Determination of compression properties.” That is, using a tensilon universal test machine (UCT-10T, commercially available from Orientec Co., Ltd.), the compressive strength at 25% compression (at 10 mm displacement) was measured for a test specimen with a size of 50 mm×50 mm×25 mm at a compression rate of 10 mm/min.

### Burning Rate

The burning rate (mm/min) was measured by the method according to the Federal Motor Vehicle Safety Standard FMVSS 302. The test piece (a bulk foaming factor of 40) had a size of 350 mm×100 mm×12 mm (thickness), and skin layers were present on at least two surfaces of 350 mm×100 mm.

The flame retardancy was classified as 0 mm/min, 40 mm/min or less, 80 mm/min or less, or more than 80 mm/min based on the burning rate. When extinguishment occurred before the measurement starting point was reached, the burning rate was set as 0 mm/min, and it was evaluated as self-extinguishing.

### Example 1

### Preparation of Seed Particles

F744NP (random copolymer, a melting point of 140° C., and an ethylene content of 7 mass %, commercially available from Prime Polymer Co., Ltd.) as a polypropylene resin (A) and EF0505 (a melting point of 108° C. and a vinyl acetate content of 4.7 mass %, commercially available from Asahi Kasei Corporation) as an ethylene-vinyl acetate copolymer (B) were put into a tumbler mixer in a mass ratio of 60:40 and mixed for 10 minutes to obtain a resin mixture (base resin).

The obtained resin mixture was supplied to an extruder, melt-kneaded at a temperature of 230 to 250° C., granulated by an underwater cutting method, and cut into an ellipsoidal shape (oval) to obtain polypropylene resin particles (seed particles, an average mass of 0.6 mg) modified with an ethylene-vinyl acetate copolymer.

### Preparation of Seed Polymer Particles Composite Resin Particles)

In an autoclave having an inner capacity of 5 L and having a stirrer, 40 g of magnesium pyrophosphate (dispersing agent), 0.6 g of sodium dodecylbenzenesulfonate (surfactant), 0.15 g of sodium nitrite (polymerization inhibitor a), and 2 kg of pure water were added to obtain a dispersion medium. 600 g of seed particles were dispersed in the dispersion medium at 30° C. and held for 10 minutes, and then heated at 60° C. to obtain a suspension. In addition, while holding the suspension at 60° C., a solution obtained by dissolving 0.6 g of dicumyl peroxide (polymerization initiator) and 0.03 g of 2,2-methylenebis(4-methyl-6-t-butylphenol) (polymerization inhibitor b) in 300 g of styrene monomers was added dropwise over 30 minutes, and then held for 30 minutes to impregnate the seed particles with the styrene monomers. After the impregnation, the temperature was raised to 140° C. and polymerization (first polymerization) was performed at this temperature for 2 hours.

Next, a dispersion solution obtained by dispersing 3 g of sodium dodecylbenzenesulfonate in 20 g of pure water was added dropwise to the reaction solution cooled to 115° C. over 10 minutes. Next, a solution obtained by dissolving 6 g of t-butyl peroxybenzoate (polymerization initiator) in 1,100 g of styrene monomers was added dropwise at a rate corresponding to 0.05 parts by mass/sec with respect to 100 parts by mass of the seed particles. Next, a dispersion medium prepared by dispersing 10 g (0.5%) of ethylene bis(stearamide) (bubble adjusting agent) in 100 g of pure water was added dropwise over 30 minutes, and after dropwise addition, the temperature was maintained at 115° C. for 1 hour to impregnate the seed particles with the styrene monomers and the bubble adjusting agent. After the impregnation, the temperature was raised to 140° C. and this temperature was maintained for 3 hours to cause polymerization (second polymerization).

60 g of TAIC-6B (tris(2,3-dibromopropyl)isocyanurate, commercially available from Nihon Kasei Co., Ltd.) as a flame retardant, and 10 g of biscumyl (product number: Perkadox 30 (2,3-dimethyl-2,3-diphenylbutane), commercially available from Kayaku Nouryon Corporation) as a flame retardant assistant were added to this reaction solution. After addition, the temperature of the reaction system was raised to 140° C., and stirring was continued for 3 hours to prepare flame retardant-containing composite resin particles (the ratio of the total mass of the polypropylene resin (A) and the ethylene-vinyl acetate copolymer (B) to the polystyrene mass was 30:70). Next, the temperature was lowered to 30° C. or lower, and the seed polymer particles (composite resin particles) were removed from the autoclave. The molecular weight of the obtained composite resin particles was measured, and the results are shown in Table 1.

### Preparation of Foamable Particles

15 kg of the obtained seed polymer particles and 7.5 g of polyethylene glycol (product name PEG #300, commercially available from NOF Corporation) were put into a pressure-resistant rotary mixer having an inner capacity of 50 L, rotated, and maintained for 10 minutes, and then heated to 70° C. Next, 2, 550 g of pentane containing 97% or more of isopentane (product name isopentane, commercially available from SK Sangyo Co., Ltd.) was added while rotating at this temperature. Rotation was continued at 70° C. for 3 hours, and thus impregnation with the foaming agent and adjustment of the water content in the particles were performed. Then, the temperature was lowered to 15° C., foamable particles were produced, and the foamable particles were removed from the mixer. In the method of wet-impregnating with a foaming agent, a dehydration step was necessary, but in this method, a dehydration step was unnecessary.

### Cryopreservation (at −25° C. for 7 Days) of Foamable Particles

Among the obtained foamable particles, 1,000 g of the foamable particles were filled into a 2 L aluminum sealed container, and stored for 168 hours (for 7 days) in a freezer set at −25° C. The foamable particles before and after cryopreservation were subjected to various evaluations, and the results are shown in Table 1.

### Preparation of Foamed Particles

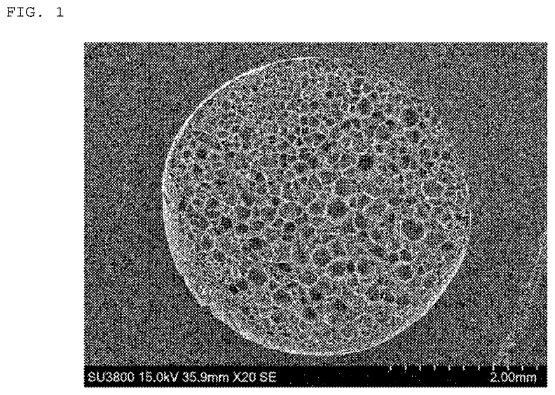

The container filled with the cryopreserved foamable particles (1,000 g) was opened, placed in a cylindrical pre-foaming machine having an inner capacity of 50 L and a stirrer, and heated with a water vapor at 0.02 MPa while stirring to prepare foamed particles having a bulk density of 25 kg/m³ (also generally called pre-foamed particles). The foamed particles were classified using a 0.9 mm mesh sieve to obtain foamed particles. The obtained foamed particles were subjected to various evaluations, and the results are shown in Table 1. Here, in Table 1, the notation “no foaming” indicates that the foamable particles did not foam sufficiently, and foamed particles having a bulk density of 25 kg/m³ were not obtained. In addition, FIG. 1 shows a scanning electron microscope (SEM) image of the cross section of the obtained foamable particle.

### Preparation of Foamed Molded Article

The obtained foamed particles were left at 23° C. for 1 day, and then filled into a molding die (molding space dimensions: length 400 mm×width 300 mm×thickness 30 mm) of a foam bead automatic molding machine (DPM-7454, commercially available from DABO Japan Co., Ltd.). A water vapor at 0.11 MPa was introduced into the mold for 30 seconds to heat and foam the foamed particles, the temperature was then lowered until the maximum surface pressure of the foamed molded article fell to 0.01 MPa, and thereby a foamed molded article having a density of 25 kg/m³ was obtained.

The obtained foamed molded article had a favorable appearance and fusion state. In addition, the obtained foamed molded article was subjected to various tests. The results are shown in Table 1.

### Examples 2 to 4 and Comparative Examples 1 and 3

Seed particles, composite resin particles, foamable particles, foamed particles, and foamed molded articles were obtained in the same manner as in Example 1 except that the polymerization conditions, the amount of the bubble adjusting agent used and the like were changed to those shown in Tables 1 and 2. Here, when a chain transfer agent was used (Comparative Example 3), the chain transfer agent was added in the second polymerization step stage, and 2,4-diphenyl-4-methyl-1-pentene was used as the chain transfer agent. The obtained composite resin particles, foamable particles, foamed particles, and foamed molded article were subjected to various evaluations. The results are shown in Tables 1 and 2.

### Comparative Example 2 (Wet Impregnation with Pentane

Composite resin particles were obtained in the same manner as in Example 1. The obtained composite resin particles were wet-impregnated with pentane to prepare foamable particles. That is, 2 kg of the composite resin particles, 2 L of water, and 2.0 g of sodium dodecylbenzenesulfonate were put into a 5 L autoclave having a stirrer, and 300 g (520 mL) of pentane containing 97% or more of isopentane (product name isopentane, commercially available from SK Sangyo Co., Ltd.) was then put into the autoclave. Then, the temperature was raised to 70° C. and stirring was continued for 4 hours. Then, the temperature was lowered to 30° C. or lower, and the particles were removed from the autoclave and dehydrated and dried to obtain foamable particles. Using the obtained foamable particles, foamed particles, foamable particle, and a foamed molded article were produced in the same manner as in Example 1. The obtained composite resin particles, foamable particles, foamed particles, and foamed molded article were subjected to various evaluations. The results are shown in Table 2.

### Example 5 (Example Using Carbon Component)

### Preparation of Seed Particles

F744NP as a polypropylene resin (A), EF0505 as an ethylene-vinyl acetate copolymer (B), EF0505 as an ethylene copolymer (B1), and 10H381 (product name: PPRM-10H381, a carbon black content of 45 mass %, and a linear low-density polyethylene content of 55 mass %, commercially available from Dainichiseika Color & Chemicals Mfg. Co., Ltd.) as carbon MB (C) were put into a tumbler mixer in a mass ratio of 71.0:17.8:11.2 and mixed for 10 minutes to obtain a resin mixture (base resin).

The obtained resin mixture was supplied to an extruder, melt-kneaded at a temperature of 230 to 250° C., granulated by an underwater cutting method, and cut into an ellipsoidal (oval) shape to obtain polypropylene resin particles (seed particles, an average mass of 0.6 mg) modified with an ethylene-vinyl acetate copolymer.

### Preparation of Seed Polymer Particles (Composite Resin Particles)

In an autoclave having an inner capacity of 5 L and having a stirrer, 40 g of magnesium pyrophosphate (dispersing agent), 0.6 g of sodium dodecylbenzenesulfonate (surfactant), 0.15 g of sodium nitrite (polymerization inhibitor a), and 2 kg of pure water were added to obtain a dispersion medium. 600 g of seed particles were dispersed in the dispersion medium at 30° C. and held for 10 minutes, and then heated at 60° C. to obtain a suspension. In addition, while holding the suspension at 60° C., a solution obtained by dissolving 0.6 g of dicumyl peroxide (polymerization initiator) and 0.03 g of 2,2-methylenebis(4-methyl-6-t-butylphenol) (polymerization inhibitor b) in 300 g of styrene monomers was added dropwise over 30 minutes and then held for 30 minutes to impregnate the seed particles with the styrene monomers. After the impregnation, the temperature was raised to 140° C. at a rate of 1° C./min in order to control the molecular weight, and polymerization (first polymerization) was performed at this temperature for 2 hours.

Next, a dispersion solution obtained by dispersing 3 g of sodium dodecylbenzenesulfonate in 20 g of pure water was added dropwise to the reaction solution cooled to 125° C. over 10 minutes. Next, a solution obtained by dissolving 6 g of 2,2-methylenebis(4-methyl-6-t-butylphenol) (polymerization initiator) in 1,100 g of styrene monomers was added dropwise at a rate corresponding to 0.05 parts by mass/sec with respect to 100 parts by mass of the seed particles. After dropwise addition, the temperature was maintained at 125° C. for 1 hour to impregnate the seed particles with the styrene monomers. After the impregnation, the temperature was raised to 140° C. for 20 minutes and this temperature was maintained for 3 hours to cause polymerization (second polymerization).

60 g of TAIC-6B as a flame retardant and 20 g of biscumyl as a flame retardant assistant were added to this reaction solution. After addition, the temperature of the reaction system was raised to 140° C., and stirring was continued for 3 hours to prepare flame retardant-containing composite resin particles (the ratio of the total mass of the polypropylene resin (A) and the ethylene-vinyl acetate copolymer (B) to the polystyrene mass was 30:70). Next, the temperature was lowered to 30° C. or lower, and the seed polymer particles (composite resin particles) were removed from the autoclave. The molecular weight of the obtained composite resin particles was measured, and the results are shown in Table 3.

Using the obtained composite resin particles, foamable particles, foamed particles, and a foamed molded article were obtained in the same manner as in Example 1. The obtained composite resin particles, foamable particles, foamed particles, and foamed molded article were subjected to various evaluations. The results are shown in Table 3.

### Example 6 (Example Using Carbon Component)

Seed particles were obtained in the same manner as in Example 5.

### Preparation of Seed Polymer Particles (Composite Resin Particles)

In an autoclave having an inner capacity of 5 L and having a stirrer, 40 g of magnesium pyrophosphate (dispersing agent), 0.6 g of sodium dodecylbenzenesulfonate (surfactant), 0.15 g of sodium nitrite (polymerization inhibitor a), and 2 kg of pure water were added to obtain a dispersion medium. 600 g of seed particles were dispersed in the dispersion medium at 30° C. and held for 10 minutes, and then heated at 60° C. to obtain a suspension. In addition, while holding the suspension at 60° C., a solution obtained by dissolving 0.6 g of dicumyl peroxide (polymerization initiator) and 0.03 g of 2,2-methylenebis(4-methyl-6-t-butylphenol) (polymerization inhibitor b) in 300 g of styrene monomers was added dropwise over 30 minutes, and then held for 30 minutes to impregnate the seed particles with the styrene monomers. After the impregnation, the temperature was raised to 140° C. at a rate of 1° C./min in order to control the molecular weight, and polymerization (first polymerization) was performed at this temperature for 2 hours.

Next, a dispersion solution obtained by dispersing 3 g of sodium dodecylbenzenesulfonate in 20 g of pure water was added dropwise to the reaction solution cooled to 125° C. over 10 minutes. Next, a solution obtained by dissolving 15 g of butyl acrylate and 6 g of 2,2-methylenebis(4-methyl-6-t-butylphenol) (polymerization initiator) in 1,085 g of styrene monomers was added dropwise at a rate corresponding to 0.05 parts by mass/sec with respect to 100 parts by mass of the seed particles. After dropwise addition, the temperature was maintained at 125° C. for 1 hour to impregnate the seed particles with the styrene monomers. Next, a dispersion medium prepared by dispersing 20 g (1.0%) of ethylene bis(stearamide) (bubble adjusting agent) in 100 g of pure water was added dropwise over 30 minutes, and after the impregnation, the temperature was raised to 140° C. for 20 minutes and this temperature was maintained for 3 hours to cause polymerization (second polymerization).

60 g of TAIC-6B as a flame retardant and 20 g of biscumyl as a flame retardant assistant were added to this reaction solution. After addition, the temperature of the reaction system was raised to 140° C., and stirring was continued for 3 hours to prepare flame retardant-containing composite resin particles (the ratio of the total mass of the polypropylene resin (A) and the ethylene-vinyl acetate copolymer (B) to the polystyrene mass was 30:70). Next, the temperature was lowered to 30° C. or lower, and the seed polymer particles (composite resin particles) were removed from the autoclave. The molecular weight of the obtained composite resin particles was measured, and the results are shown in Table 3.

Using the obtained composite resin particles, foamable particles, foamed particles, and a foamed molded article were obtained in the same manner as in Example 5. The obtained composite resin particles, foamable particles, foamed particles, and foamed molded article were subjected to various evaluations. The results are shown in Table 3.

### Comparative Example 4 (Wet Impregnation with Pentane)

Composite resin particles were obtained in the same manner as in Example 6. The obtained composite resin particles were wet-impregnated with pentane to prepare foamable particles. That is, using the composite resin particles, foamable particles were obtained in the same manner as in Comparative Example 2. Using the obtained foamable particles, foamed particles, foamable particles, and a foamed molded article were produced in the same manner as in Example 1. The obtained composite resin particles, foamable particles, foamed particles, and foamed molded article were subjected to various evaluations. The results are shown in Table 3.

TABLE 1

| | | Example 1 | Example 2 | Example 3 | Example 4 |
|---|---|---|---|---|---|
| Seed | (A)PP | F744NP | F744NP | F744NP | F744NP |
| particles | (B)EVA | EF0505 | EF0505 | EF0505 | EF0505 |
| | A:B mass ratio | 60:40 | 60:40 | 60:40 | 80:20 |
| Polymerization | Styrene monomer addition rate in second | 0.05 | 0.05 | 0.05 | 0.05 |
| conditions | step (parts by mass/sec) | | | | |
| | Styrene monomer addition temperature in | 115° C. | 115° C. | 120° C. | 115° C. |
| | second step | | | | |
| | Amount of chain transfer agent added | No | No | No | No |
| | (mass % with respect to PS mass) | | | | |
| Composite | A + B:PS mass ratio | 30:70 | 30:70 | 30:70 | 30:70 |
| resin | Molecular weight (Mw × 10\hat{ }3) | 472 | 466 | 389 | 455 |
| particles | Amount of bubble adjusting agent | 0.5 | 1.5 | 1.0 | 0.5 |
| Productivity | Dehydration step | Unnecessary | Unnecessary | Unnecessary | Unnecessary |
| Foamable | Foaming agent content (mass %) | 11.2 | 13.2 | 12.8 | 13.8 |
| particles | Water content (mass %) | 0.3 | 0.3 | 0.3 | 0.2 |
| (before | Foaming power of foamed particles (times) | 48 | 52 | 49 | 44 |
| freezing) | | | | | |
| Foamable | Foaming power of foamed particles (times) | 45 | 49 | 49 | 41 |
| particles | Particle adhesion during cryopreservation | ∘ | ∘ | ∘ | ∘ |
| (after | | | | | |
| freezing) | | | | | |
| Foamed | Bulk density (kg/m³) | 25 | 25 | 25 | 25 |
| particles | Average bubble diameter (μm) | 180 | 154 | 239 | 167 |
| Foamed | 25% compressive strength (MPa) | 1.73 | 1.81 | 1.72 | 1.77 |
| molded | Burning rate (mm/min) | Self- | Self- | Self- | Self- |
| article | | extinguishing | extinguishing | extinguishing | extinguishing |

TABLE 2

| | | Comparative | Comparative | Comparative |
|---|---|---|---|---|
| | | Example 1 | Example 2 | Example 3 |
| Seed | (A)PP | F744NP | F744NP | F744NP |
| particles | (B)EVA | EF0505 | EF0505 | EF0505 |
| | A:B mass ratio | 60:40 | 60:40 | 60:40 |
| Polymerization | Styrene monomer addition rate in second | 0.05 | 0.05 | 0.15 |
| conditions | step (parts by mass/sec) | | | |
| | Styrene monomer addition temperature in | 125° C. | 115° C. | 115° C. |
| | second step | | | |
| | Amount of chain transfer agent added | No | No | 0.2 |
| | (mass % with respect to PS mass) | | | |
| Composite | A + B:PS mass ratio | 30:70 | 30:70 | 30:70 |
| resin | Molecular weight (Mw × 10\hat{ }3) | 297 | 472 | 299 |
| particles | Amount of bubble adjusting agent | 0.15 | 0.5 | 0.20 |
| Productivity | Dehydration step | Unnecessary | Necessary | Necessary |
| Foamable | Foaming agent content (mass %) | 12.4 | 11.4 | 13.1 |
| particles | Water content (mass %) | 0.2 | 1.9 | 0.3 |
| (before | Foaming power of foamed particles (times) | 42 | 46 | 46 |
| freezing) | | | | |
| Foamable | Foaming power of foamed particles (times) | 22 | 48 | 28 |
| particles | Particle adhesion during cryopreservation | ∘ | x | ∘ |
| (after | | | | |
| freezing) | | | | |
| Foamed | Bulk density (kg/m³) | No foaming | 25 | No foaming |
| particles | Average bubble diameter (μm) | | 140 | |
| Foamed | 25% compressive strength (MPa) | | 1.71 | |
| molded | Burning rate (mm/min) | | Self- | |
| article | | | extinguishing | |

TABLE 3

| | | | | Comparative |
|---|---|---|---|---|
| | | Example 5 | Example 6 | Example 4 |
| Seed | (A)PP | F744NP | F744NP | F744NP |
| particles | (B)EVA | EF0505 | EF0505 | EF0505 |
| | (C) Carbon MB | 10H381 | 10H381 | 10H381 |
| | A:B mass ratio | 80:20 | 80:20 | 80:20 |
| | A:B:C mass ratio | 71.0:17.8:11.2 | 71.0:17.8:11.2 | 71.0:17.8:11.2 |
| | Amount of carbon component added (mass %) | 5.0 | 5.0 | 5.0 |
| Polymerization | Styrene monomer addition rate in second | 0.05 | 0.05 | 0.05 |
| conditions | step (parts by mass/sec) | | | |
| | Styrene monomer addition temperature in | 125° C. | 125° C. | 125° C. |
| | second step | | | |
| | Amount of chain transfer agent added | No | No | No |
| | (mass % with respect to PS mass) | | | |
| Composite | A + B + C:PS mass ratio | 30:70 | 30:70 | 30:70 |
| resin | Molecular weight (Mw × 10\hat{ }3) | 302 | 331 | 331 |
| particles | Amount of bubble adjusting agent | — | 1.0 | 1.0 |
| Productivity | Dehydration step | Unnecessary | Unnecessary | Necessary |
| Foamable | Foaming agent content (mass %) | 10.7 | 11.8 | 11.2 |
| particles | Water content (mass %) | 0.2 | 0.3 | 2.5 |
| (before | Foaming power of foamed particles (times) | 44 | 47 | 49 |
| freezing) | | | | |
| Foamable | Foaming power of foamed particles (times) | 41 | 41 | 45 |
| particles | Particle adhesion during cryopreservation | ∘ | ∘ | x |
| (after | | | | |
| freezing) | | | | |
| Foamed | Bulk density (kg/m³) | 25 | 25 | 25 |
| particles | Average bubble diameter (μm) | 320 | 227 | 168 |
| Foamed | 25% compressive strength (MPa) | 1.72 | 1.78 | 1.71 |
| molded | Burning rate (mm/min) | Self- | Self- | Self- |
| article | | extinguishing | extinguishing | extinguishing |

In the foamable particles of Comparative Examples 1 and 3, since the molecular weight of the resin was small, the foaming power of the foamed particles obtained from the foamable particles after freezing was significantly reduced compared to before freezing.

In the foamable particles of Comparative Example 2, pentane as a foaming agent was wet-impregnated into the composite resin particles, and thus the water content was high, and there was significant adhesion between the particles after freezing.

In the foamable particles of Example 1, the foamed particles obtained therefrom had no coarse bubble diameter. In the foamed particles of Examples 1 to 4, almost no decrease in foaming power due to cryopreservation of the foamable particles was observed. In addition, it was also confirmed that the foamed molded article obtained from the foamable particles of Examples 1 to 4 had a sufficient 25% compressive strength and flame retardancy.

In the foamed particles of Examples 5 and 6, almost no decrease in foaming power due to cryopreservation was observed. In addition, in Example 6, better foamability was confirmed by performing a bubble adjustment operation and butyl acrylate addition. On the other hand, although Comparative Example 4 exhibited excellent foamability, since many particles adhered during thawing, it was necessary to perform an operation of breaking apart the adhered foamable particles before using the foamable particles after freezing.

1. Foamable particles comprising a polypropylene resin, an ethylene-vinyl acetate copolymer, a polystyrene resin, and a foaming agent,
wherein the foamable particles are obtained by incorporating a foaming agent into composite resin particles prepared by impregnating and polymerizing styrene monomers into seed particles containing a polypropylene resin and an ethylene-vinyl acetate copolymer,
the foaming agent is pentane,
the water content of the foamable particles with respect to the mass of the foamable particles is 1 mass % or less, and
(1) the foamable particles contain 0.1 to 4.0 mass % of a carbon component with respect to the mass of the foamable particles and the mass average molecular weight (in terms of polystyrene) of the foamable particles is 250,000 to 550,000, or
(2) the foamable particles do not contain a carbon component or contain less than 0.1 mass % of a carbon component with respect to the mass of the foamable particles, and the mass average molecular weight (in terms of polystyrene) of the foamable particles is 350,000 to 550,000.

2. The foamable particles according to claim 1, wherein the content of the polypropylene resin is 2 to 50 mass %, the content of the ethylene-vinyl acetate copolymer is 2 to 45 mass %, the content of the polystyrene resin is 40 to 95 mass %, and the mass ratio (PP:EVA) of the content (PP) of the polypropylene resin to the content (EVA) of the ethylene-vinyl acetate copolymer is 50:50 to 85:15.

3. The foamable particles according to claim 1, wherein the content of pentane with respect to the mass of the foamable particles is 6 to 15 mass %.

4. The foamable particles according to claim 1, wherein the foamable particles contain 0.1 to 4.0 mass % of a carbon component with respect to the mass of the foamable particles and contain 1.5 to 6.0 mass % of a flame retardant with respect to the mass of the foamable particles excluding the mass of the flame retardant, and the mass average molecular weight (in terms of polystyrene) of the foamable particles is 250,000 to 550,000.

5. The foamable particles according to claim 1, which contain 0.3 to 2.5 parts by mass of a bubble adjusting agent with respect to 100 parts by mass of the foamable particles.

6. The foamable particles according to claim 5, wherein the bubble adjusting agent is ethylene bis(stearamide) and/or a polyethylene wax.

7. The foamable particles according to claim 1, which have a bulk density of 20 kg/m³ to 50 kg/m³.

8. Foamed particles obtained by pre-foaming the foamable particles according to claim 1.

9. The foamed particles according to claim 8, which have an average bubble diameter of 80 μm to 400 μm.

10. A foamed molded article made from a fused component of the foamed particles according to claim 8.

11. The foamed molded article according to claim 10, which has a density of 20 kg/m³ to 50 kg/m³.

12. An automobile member comprising the foamed molded article according to claim 10.

13. A method of producing foamable particles containing a polypropylene resin, an ethylene-vinyl acetate copolymer, a polystyrene resin, and a foaming agent,
wherein the foamable particles are foamable particles according to claim 1, and
the foaming agent is pentane,
the production method comprises a step in which, in a sealed container, without using an aqueous medium, pentane is added and impregnated into composite resin particles prepared by impregnating and polymerizing styrene monomers into seed particles containing a polypropylene resin and an ethylene-vinyl acetate copolymer to obtain foamable particles, and
pentane addition and impregnation are performed at a temperature from a temperature (T+10) (10° C. higher than the boiling point (T) of pentane) to a temperature (T+60) (60° C. higher than the boiling point (T) of pentane).

14. The method of producing foamed particles according to claim 8, comprising
freezing the foamable particles
thawing the frozen foamable particles; and
pre-foaming the thawed foamable particles,
wherein the foamable particles comprise a polypropylene resin, an ethylene-vinyl acetate copolymer, a polystyrene resin, and a foaming agent,
wherein the foamable particles are obtained by incorporating a foaming agent into composite resin particles prepared by impregnating and polymerizing styrene monomers into seed particles containing a polypropylene resin and an ethylene-vinyl acetate copolymer,
the foaming agent is pentane,
the water content of the foamable particles with respect to the mass of the foamable particles is 1 mass % or less, and
(1) the foamable particles contain 0.1 to 4.0 mass % of a carbon component with respect to the mass of the foamable particles and the mass average molecular weight (in terms of polystyrene) of the foamable particles is 250,000 to 550,000, or
(2) the foamable particles do not contain a carbon component or contain less than 0.1 mass % of a carbon component with respect to the mass of the foamable particles, and the mass average molecular weight (in terms of polystyrene) of the foamable particles is 350.000 to 550,000.
